(19) United States
(12) Patent Application Publication
(10) Pub. No.: US 2005/0165120 A1
(43) Pub. Date: Jul. 28, 2005

(54) Process for phase transfer of hydrophobic nanoparticles

(76) Inventors: Ashavani Kumar, Troy, NY (US); Anita Subhash Swami, Pune (IN); Murali Sastry, Pune (IN)

Correspondence Address: MEYERTONS, HOOD, KIVLIN, KOWERT & GOETZEL, P.C., P.O. BOX 398, AUSTIN, TX, 78767-0398, US

(21) Appl. No.: 10/763,060

(22) Filed: Jan. 22, 2004

(51) Int. Cl. B01F 17/00

(52) U.S. Cl. 516/78

(57) ABSTRACT

A process for extraction of nanoparticles into aqueous phase by complexation with water soluble surfactants such as cetyltrimethyl ammonium bromide (CTAB), sodium dodecyl sulfate (SDS) etc., wherein a bi-phasic mixture is prepared in which, hydrophobized nanoparticles are in organic medium, and surfactant molecules are in aqueous phase. An emulsion is formed on vigorous shaking of the bi-phasic mixture, and after phase separation metal nanoparticles transfer to aqueous medium.

This invention relates to a method for the phase transfer of hydrophobic nanoparticles from organic to aqueous phase. More particularly it relates to a process for extraction of nanoparticles into aqueous phase by complexation with water soluble surfactants such as cetyltrimethyl ammonium bromide (CTAB), sodium dodecyl sulfate (SDS) etc. A bi-phasic mixture is prepared in which, hydrophobized nanoparticles are in organic medium, and surfactant molecules are in aqueous phase. An emulsion is formed on vigorous shaking of the bi-phasic mixture, and after phase separation metal nanoparticles transfer to aqueous medium.

The stability and shelf life of nanoparticles increases upon modification with CTAB and they can be stored as powders and redispersed when desired. Nanoparticles exhibit prominent feature in the UV-visible region of the electromagnetic spectrum due to the surface plasmon of resonance. The variations in these features can be co-related to the nanoparticle stability. CTAB modified nanoparticles are useful for various applications such as catalysis, electron microscopy markers, detection of genetic disorders, immunoassay and self-assembly of surface modified nanoparticles.

In the prior art process for the phase transfer of hydrophobic nanoparticles by place exchange mechanism to functionalize alkanethiol-capped organically soluble gold nanoparticles with carboxylic acid groups [Simard, J.; Briggs, C.; Boal, A. K.; Rotello, V. M. Chem. Commun. 2000, 1943.] in polar medium is available. This process is based on replacement of octanethiol molecules bound to the surface of 2 nm diameter gold nanoparticles by 11-thioundecanoic acid. Under the experimental conditions adopted by Rotello et al, the ratio of ω-thiol carboxylic acid: octanethiol on the gold nanoparticle surface after place exchange was found to be 1:1. The carboxylic acid derivatized gold nanoparticles were washed with dichloromethane and were found to be soluble in water

In yet another process a facile and rapid one-step method for the direct and complete transfer of gold and palladium nanoparticles synthesized in toluene and stabilized by tetraalkylammonium salts across the phase boundary. This was accomplished by addition of an aqueous 0.1 M 4-dimethlyaminopyridine (DMAP) solution to aliquots of the gold/platinum nanoparticles in toluene. The DMAP molecules replace the tetraalkylammonium salts and form a labile donor-acceptor complex with the gold atoms on the surface of the nanoparticles through the endocyclic nitrogen atoms. [(a) Gittins, D. J.; Caruso, F. Angew. Chem. Int. Ed. 2001, 40, 3001; (b) Gittins, D. J.; Caruso, F. ChemPhysChem 2002, 3, 110.]

The drawbacks of these methods are:
(1) The processes are complicated and involve a lot of maneuvering.
(2) The processes are based on place exchange mechanism which permanently changes the chemistry of the particle surface, and results in only a small proportion of transferred material.
(3) The processes involve carboxylic/amine functionalized thiol molecule for place exchange of hydrobhobic molecules on nanoparticles which are not readily available and are more expensive.

The inventors of the present invention have, during their course of research, invented a simple two-phase shaking process by complexing hydrophobic nanoparticles with surfactant molecules at the chloroform-water interface and then phase transfer of nanoparticles in the aqueous phase.

The object of the present invention is to provide an improved process for the phase transfer of hydrophobic nanoparticles exemplified but not limited by nanoparticles such as gold, silver, platinum or semiconductor nanoparticles like cadmium sulphide.

Another object is to phase transfer of nanoparticle using different polar solvents for commercial use.

Accordingly the present invention provides a process for the phase transfer of hydrophobic nanoparticles from organic phase to aqueous phase which comprises mixing an aqueous solution of a surfactant with a solution of hydrophobic nanoparticles in an organic solvent under agitation, for a period of 30 to 60 minutes to obtain the hydrophilic or water dispersible nanoparticles.

In one of the embodiments of the present invention nanoparticles of which the powders could be obtained may be the inorganic nanoparticles or semiconductor nanoparticles exemplified but not limited to gold, silver, platinum, palladium, ruthenium, cadmium sulphide, cadimium selinide, cadmium telluride, zinc sulphide gold sulphide, silver sulphide, titania and zirconia nanoparticles.

In another embodiment of the present invention the surfactant used may be cationic or anionic such as sodium octylsulfate, sodium decylsulfate, sodium dodecylsulfate, sodium dodecanoate, aerosol OT(AOT), dodecyl trimethyl ammonium bromide, hexadecyltrimethyl ammonium bromide (CTAB), didecyidimethyl ammonium bromide (DDAB), dihexadecyldimethyl ammonium acetate, dimyristoyl-lecithin (DMPC), dipalmitoyl-lecithin (DPPC), distearoyl-lecithin (DSPC), dodacenedimethyl propanesultaine, dodecyldimethyl amine oxide, β-d-decylglucoside.

In another embodiment of the present invention, the polar solvents used for the phase transfer of nanoparticles may be aqueous or organic polar solvents exemplified but not limited by water and other polar solvent such as water, alcohol, ketones, aldehyde like methanol, ethanol, propanol, acetone, formaldehyde, acetaldehyde, propanaldehyde.

In yet another embodiment of the present invention, the concentration of the surfactant used for the phase transfer of nanoparticles may be 2 to 10 times higher than the nanoparticle concentration.

The process of the present invention is described here in below by examples which are illustrative only and should not be constructed to limit the scope of the invention in any manner whatsoever.

### EXAMPLE 1

This example illustrates the phase transfer of hydrophobized gold nanoparticles with CTAB molecules at the chloroform-water interface and then the phase transfer of gold nanoparticles in the aqueous phase. In a typical experiment, 25 mL of hydrophobized Au (dodecylamine, octadecylamine, octadecathiol etc. capped) nanoparticles in chloroform was added to 25 mL of 10⁻³ M CTAB solution in water. The concentration of gold in chloroform was estimated to be 2×10⁻⁴ M by UV-vis. spectroscopy. Vigorous shaking of the biphasic mixture resulted in phase transfer of the gold nanoparticles from chloroform to water, giving a pink, foam-like appearance to aqueous layer. This layer was then separated from the organic layer, dried and the resulting dry powder redispersed in 25 mL of double-distilled water.

### EXAMPLE 2

This example illustrates the phase transfer of hydrophobized gold nanoparticles with sodium decylsulfate molecules at the chloroform-water interface and then the phase transfer of gold nanoparticles in the aqueous phase. In a typical experiment, 25 mL of hydrophobized Au (dodecylamine, octadecylamine, octadecathiol etc. capped) nanoparticles in chloroform was added to 25 mL of 10⁻³ M sodium decylsulfate solution in water. The concentration of gold in chloroform was estimated to be 2×10⁻⁴ M by UV-vis. spectroscopy. Vigorous shaking of the biphasic mixture resulted in phase transfer of the gold nanoparticles from chloroform to water, giving a pink, foam-like appearance to aqueous layer. This layer was then separated from the organic layer, dried and the resulting dry powder redispersed in 25 mL of double-distilled water.

### EXAMPLE 3

This example illustrates the phase transfer of hydrophobized gold nanoparticles with sodium dodecyl sulphate(SDS) molecules at the chloroform-water interface and then the phase transfer of gold nanoparticles in the aqueous phase. In a typical experiment, 25 mL of hydrophobized Au (dodecylamine, octadecylamine, octadecathiol etc. capped) nanoparticles in chloroform was added to 25 mL of 10⁻³ M sodoum dodecyl sulphate(SDS) solution in water. The concentration of gold in chloroform was estimated to be 2×10⁻⁴ M by UV-vis. spectroscopy. Vigorous shaking of the biphasic mixture resulted in phase transfer of the gold nanoparticles from chlorofom to water, giving a pink, foam-like appearance to aqueous layer. This layer was then separated from the organic layer, dried and the resulting dry powder redispersed in 25 mL of double-distilled water.

### EXAMPLE 4

This example illustrates the phase transfer of hydrophobized gold nanoparticles with sodium decanoate molecules at the chloroform-water interface and then the phase transfer of gold nano-particle in the aqueous phase. In a typical experiment, 25 mL of hydrophobized Au (dodecylamine, octadecylamine, octadecathiol etc. capped) nanoparticles in chloroform was added to 25 mL of 10⁻³ M sodium decanoate solution in water. The concentration of gold in chloroform was estimated to be 2×10⁻⁴ M by UV-vis. spectroscopy. Vigorous shaking of the biphasic mixture resulted in phase transfer of the gold nanoparticles from chlorofom to water, giving a pink, foam-like appearance to aqueous layer. This layer was then separated from the organic layer, dried and the resulting dry powder redispersed in 25 mL of double-distilled water.

### EXAMPLE 5

This example illustrates the phase transfer of hydrophobized gold nanoparticles with aerosol OT (AOT) molecules at the chloroform-water interface and then the phase transfer of gold nano-particle in the aqueous phase. In a typical experiment, 25 mL of hydrophobized Au (dodecylamine, octadecylamine, octadecathiol etc. capped) nanoparticles in chloroform was added to 25 mL of 10⁻³ M aerosol OT (AOT) solution in water. The concentration of gold in chloroform was estimated to be 2×10⁻⁴ M by UV-vis. spectroscopy. Vigorous shaking of the biphasic mixture resulted in phase transfer of the gold nanoparticles from chlorofom to water, giving a pink, foam-like appearance to aqueous layer. This layer was then separated from the organic layer, dried and the resulting dry powder redispersed in 25 mL of double-distilled water.

### EXAMPLE 6

This example illustrates the phase transfer of hydrophobized gold nanoparticles with Dodecyl trimethyl ammonium bromide molecules at the chloroform-water interface and then the phase transfer of gold nano-particle in the aqueous phase. In a typical experiment, 25 mL of hydrophobized Au (dodecylamine, octadecylamine, octadecathiol etc. capped) nanoparticles in chloroform was added to 25 mL of 10⁻³ M of Dodecyl trimethyl ammonium bromide solution in water. The concentration of gold in chloroform was estimated to be 2×10⁻⁴ M by UV-vis. spectroscopy. Vigorous shaking of the biphasic mixture resulted in phase transfer of the gold nanoparticles from chloroform to water, giving a pink, foam-like appearance to aqueous layer. This layer was then separated from the organic layer, dried and the resulting dry powder redispersed in 25 mL of double-distilled water.

### EXAMPLE 7

This example illustrates the phase transfer of hydrophobized gold nanoparticles with didecyidimethyl ammonium bromide (DDAB) molecules at the chloroform-water interface and then the phase transfer of gold nanoparticle in the aqueous phase. In a typical experiment, 25 mL of hydrophobized Au (dodecylamine, octadecylamine, octadecathiol etc. capped) nanoparticles in chloroform was added to 25 mL of 10⁻³ M didecyldimethyl ammonium bromide (DDAB) solution in water. The concentration of gold in chloroform was estimated to be 2×10⁻⁴ M by UV-vis. spectroscopy. Vigorous shaking of the biphasic mixture resulted in phase transfer of the gold nanoparticles from chlorofom to water, giving a pink, foam-like appearance to aqueous layer. This layer was then separated from the organic layer, dried and the resulting dry powder redispersed in 25 mL of double-distilled water.

### EXAMPLE 8

This example illustrates the phase transfer of hydrophobized gold nanoparticles with Dihexadecyldimethyl ammonium acetate (DHDAA) molecules at the chloroform-water interface and then the phase transfer of gold nano-particle in the aqueous phase. In a typical experiment, 25 mL of hydrophobized Au (dodecylamine, octadecylamine, octadecathiol etc. capped) nanoparticles in chloroform was added to 25 mL of 10⁻³ M Dihexadecyldimethyl ammonium acetate (DHDAA) solution in water. The concentration of gold in chloroform was estimated to be 2×10⁻⁴ M by UV-vis. spectroscopy. Vigorous shaking of the biphasic mixture resulted in phase transfer of the gold nanoparticles from chloroform to water, giving a pink, foam-like appearance to aqueous layer. This layer was then separated from the organic layer, dried and the resulting dry powder redispersed in 25 mL of double-distilled water.

### EXAMPLE 9

This example illustrates the phase transfer of hydrophobized gold nanoparticles with dimyristoyl-lecithin (DMPC) molecules at the chloroform-water interface and then the phase transfer of gold nano-particle in the aqueous phase. In a typical experiment, 25 mL of hydrophobized Au (dodecylamine, octadecylamine, octadecathiol etc. capped) nanoparticles in chloroform was added to 25 mL of 10⁻³ M dimyristoyl-lecithin (DMPC) solution in water. The concentration of gold in chloroform was estimated to be 2×10⁻⁴ M by UV-vis. spectroscopy. Vigorous shaking of the biphasic mixture resulted in phase transfer of the gold nanoparticles from chloroform to water, giving a pink, foam-like appearance to aqueous layer. This layer was then separated from the organic layer, dried and the resulting dry powder redispersed in 25 mL of double-distilled water.

### EXAMPLE 10

This example illustrates the phase transfer of hydrophobized gold nanoparticles with dipalmitoyl-lecithin (DPPC) molecules at the chloroform-water interface and then the phase transfer of gold nano-particle in the aqueous phase. In a typical experiment, 25 mL of hydrophobized Au (dodecylamine, octadecylamine, octadecathiol etc. capped) nanoparticles in chloroform was added to 25 mL of 10⁻³ M dipalmitoyl-lecithin (DPPC) solution in water. The concentration of gold in chloroform was estimated to be 2×10⁻⁴ M by UV-vis. spectroscopy. Vigorous shaking of the biphasic mixture resulted in phase transfer of the gold nanoparticles from chloroform to water, giving a pink, foam-like appearance to aqueous layer. This layer was then separated from the organic layer, dried and the resulting dry powder redispersed in 25 mL of double-distilled water.

### EXAMPLE 11

This example illustrates the phase transfer of hydrophobized gold nanoparticles with distearoyl-lecithin (DSPC) molecules at the chloroform-water interface and then the phase transfer of gold nano-particle in the aqueous phase. In a typical experiment, 25 mL of hydrophobized Au (dodecylamine, octadecylamine, octadecathiol etc. capped) nanoparticles in chloroform was added to 25 mL of 10⁻³ M distearoyl-lecithin (DSPC) solution in water. The concentration of gold in chloroform was estimated to be 2×10⁻⁴ M by UV-vis. spectroscopy. Vigorous shaking of the biphasic mixture resulted in phase transfer of the gold nanoparticles from chlorofom to water, giving a pink, foam-like appearance to aqueous layer. This layer was then separated from the organic layer, dried and the resulting dry powder redispersed in 25 mL of double-distilled water.

### EXAMPLE 12

This example illustrates the phase transfer of hydrophobized gold nanoparticles with dodacenedimethyl propanesultaine molecules at the chloroform-water interface and then the phase transfer of gold nano-particle in the aqueous phase. In a typical experiment, 25 mL of hydrophobized Au (dodecylamine, octadecylamine, octadecathiol etc. capped) nanoparticles in chloroform was added to 25 mL of 10⁻³ M dodacenedimethyl propanesultaine solution in water. The concentration of gold in chloroform was estimated to be 2×10⁻⁴ M by UV-vis. spectroscopy. Vigorous shaking of the biphasic mixture resulted in phase transfer of the gold nanoparticles from chloroform to water, giving a pink, foam-like appearance to aqueous layer. This layer was then separated from the organic layer, dried and the resulting dry powder redispersed in 25 mL of double-distilled water.

### EXAMPLE 13

This example illustrates the phase transfer of hydrophobized gold nanoparticles with dodecyldimethyl amine oxide molecules at the chloroform-water interface and then the phase transfer of gold nano-particle in the aqueous phase. In a typical experiment, 25 mL of hydrophobized Au (dodecylamine, octadecylamine, octadecathiol etc. capped) nanoparticles in chloroform was added to 25 mL of 10⁻³ M dodecyidimethyl amine oxide solution in water. The concentration of gold in chloroform was estimated to be 2×10⁻⁴ M by UV-vis. spectroscopy. Vigorous shaking of the biphasic mixture resulted in phase transfer of the gold nanoparticles from chloroform to water, giving a pink, foam-like appearance to aqueous layer. This layer was then separated from the organic layer, dried and the resulting dry powder redispersed in 25 mL of double-distilled water.

### EXAMPLE 14

This example illustrates the phase transfer of hydrophobized gold nanoparticles with β-d-decylglucoside molecules at the chloroform-water interface and then the phase transfer of gold nano-particle in the aqueous phase. In a typical experiment, 25 mL of hydrophobized Au (dodecylamine, octadecylamine, octadecathiol etc. capped) nanoparticles in chloroform was added to 25 mL of 10⁻³ M β-d-decylglucoside solution in water. The concentration of gold in chloroform was estimated to be 2×10⁻⁴ M by UV-vis. spectroscopy. Vigorous shaking of the biphasic mixture resulted in phase transfer of the gold nanoparticles from chloroform to water, giving a pink, foam-like appearance to aqueous layer. This layer was then separated from the organic layer, dried and the resulting dry powder redispersed in 25 mL of double-distilled water.

### EXAMPLE 15

This example illustrates the phase transfer of hydrophobized gold nanoparticles with sodium octyidulfate molecules at the chloroform-water interface and then the phase transfer of gold nano-particle in the aqueous phase. In a typical experiment, 25 mL of hydrophobized Au (dodecylamine, octadecylamine, octadecathiol etc. capped) nanoparticles in chloroform was added to 25 mL of 10⁻³ M sodium octyldulfate solution in water. The concentration of gold in chloroform was estimated to be 2×10⁻⁴ M by UV-vis. spectroscopy. Vigorous shaking of the biphasic mixture resulted in phase transfer of the gold nanoparticles from chloroform to water, giving a pink, foam-like appearance to aqueous layer. This layer was then separated from the organic layer, dried and the resulting dry powder redispersed in 25 mL of double-distilled water.

### EXAMPLE 16

This example illustrates the phase transfer of hydrophobized silver nanoparticles with CTAB molecules at the chloroform-water interface and then the phase transfer of silver nano-particle in the aqueous phase. In a typical experiment, 25 mL of hydrophobized Ag (dodecylamine, octadecylamine, octadecathiol etc. capped) nanoparticles in chloroform was added to 25 mL of 10⁻³ M CTAB solution in water. The concentration of silver in chloroform was estimated to be 2×10⁻⁴ M by UV-vis. spectroscopy. Vigorous shaking of the biphasic mixture resulted in phase transfer of the silver nanoparticles from chloroform to water, giving a yellow, foam-like appearance to aqueous layer. This layer was then separated from the organic layer, dried and the resulting dry powder redispersed in 25 mL of double-distilled water.

### EXAMPLE 17

This example illustrates the phase transfer of hydrophobized silver nanoparticles with sodium decylsulfate molecules at the organic/water interface and then the phase transfer of silver nano-particle in the aqueous phase. In a typical experiment, 25 mL of hydrophobized Ag (dodecylamine, octadecylamine, octadecathiol etc. capped) nanoparticles in chloroform was added to 25 mL of 10⁻³ M sodium decylsulfate solution in water. The concentration of silver in chloroform was estimated to be 2×10⁻⁴ M by UV-vis. spectroscopy. Vigorous shaking of the biphasic mixture resulted in phase transfer of the silver nanoparticles from chloroform to water, giving a yellow, foam-like appearance to aqueous layer. This layer was then separated from the organic layer, dried and the resulting dry powder redispersed in 25 mL of double-distilled water.

### EXAMPLE 18

This example illustrates the phase transfer of hydrophobized silver nanoparticles with sodoum dodecyl sulphate(SDS) molecules at the chloroform-water interface and then the phase transfer of silver nanoparticle in the aqueous phase. In a typical experiment, 25 mL of hydrophobized Ag (dodecylamine, octadecylamine, octadecathiol etc. capped) nanoparticles in chloroform was added to 25 mL of 10⁻³ M sodoum dodecyl sulphate(SDS) solution in water. The concentration of silver in chloroform was estimated to be 2×10⁻⁴ M by UV-vis. spectroscopy. Vigorous shaking of the biphasic mixture resulted in phase transfer of the silver nanoparticles from chloroform to aqueous phase, giving a yellow, foam-like appearance to aqueous layer. This layer was then separated from the organic layer, dried and the resulting dry powder redispersed in 25 mL of double-distilled water.

### EXAMPLE 19

This example illustrates the phase transfer of hydrophobized silver nanoparticles with sodium decanoate molecules at the chloroform water interface and then the phase transfer of silver nano-particle in the aqueous phase. In a typical experiment, 25 mL of hydrophobized Ag (dodecylamine, octadecylamine, octadecathiol etc. capped) nanoparticles in chloroform was added to 25 mL of 10⁻³ M sodium decanoate solution in water. The concentration of silver in chloroform was estimated to be 2×10⁻⁴ M by UV-vis. spectroscopy. Vigorous shaking of the biphasic mixture resulted in phase transfer of the silver nanoparticles from chloroform to aqueous phase, giving a yellow, foam-like appearance to aqueous layer. This layer was then separated from the organic layer, dried and the resulting dry powder redispersed in 25 mL of double-distilled water.

### EXAMPLE 20

This example illustrates the phase transfer of hydrophobized silver nanoparticles with aerosol OT (AOT) molecules at the chloroform water interface and then the phase transfer of silver nano-particle in the aqueous phase. In a typical experiment, 25 mL of hydrophobized Ag (dodecylamine, octadecylamine, octadecathiol etc. capped) nanoparticles in chloroform was added to 25 mL of 10⁻³ M aerosol OT (AOT) solution in water. The concentration of silver in chloroform was estimated to be 2×10⁻⁴ M by UV-vis. spectroscopy. Vigorous shaking of the biphasic mixture resulted in phase transfer of the silver nanoparticles from chloroform to aqueous phase, giving a yellow, foam-like appearance to aqueous layer. This layer was then separated from the organic layer, dried and the resulting dry powder redispersed in 25 mL of double-distilled water.

### EXAMPLE 21

This example illustrates the phase transfer of hydrophobized silver nanoparticles with Dodecyl trimethyl ammonium bromide molecules at the chloroform water interface and then the phase transfer of silver nano-particle in the aqueous phase. In a typical experiment, 25 mL of hydrophobized Ag (dodecylamine, octadecylamine, octadecathiol etc. capped) nanoparticles in chloroform was added to 25 mL of 10⁻³ M of Dodecyl trimethyl ammonium bromide solution in water. The concentration of silver in chloroform was estimated to be 2×10⁻⁴ M by UV-vis. spectroscopy. Vigorous shaking of the biphasic mixture resulted in phase transfer of the silver nanoparticles from chloroform to water, giving a yellow, foam-like appearance to aqueous layer. This layer was then separated from the organic layer, dried and the resulting dry powder redispersed in 25 mL of double-distilled water.

### EXAMPLE 22

This example illustrates the phase transfer of hydrophobized silver nanoparticles with didecyldimethyl ammonium bromide (DDAB) molecules at the chloroform-water interface and then the phase transfer of silver nanoparticle in the aqueous phase. In a typical experiment, 25 mL of hydrophobized Ag (dodecylamine, octadecylamine, octadecathiol etc. capped) nanoparticles in chloroform was added to 25 mL of 10⁻³ M didecyldimethyl ammonium bromide (DDAB) solution in water. The concentration of silver in chloroform was estimated to be 2×10⁻⁴ M by UV-vis. spectroscopy. Vigorous shaking of the biphasic mixture resulted in phase transfer of the silver nanoparticles from chloroform to water, giving a yellow, foam-like appearance to aqueous layer. This layer was then separated from the organic layer, dried and the resulting dry powder redispersed in 25 mL of double-distilled water.

### EXAMPLE 23

This example illustrates the phase transfer of hydrophobized silver nanoparticles with Dihexadecyldimethyl ammonium acetate (DHDAA) molecules at the chloroform-water interface and then the phase transfer of silver nano-particle in the aqueous phase. In a typical experiment, 25 mL of hydrophobized Ag (dodecylamine, octadecylamine, octadecathiol etc. capped) nanoparticles in chloroform was added to 25 mL of 10⁻³ M Dihexadecyldimethyl ammonium acetate (DHDAA) solution in water. The concentration of silver in chloroform was estimated to be 2×10⁻⁴ M by UV-vis. spectroscopy. Vigorous shaking of the biphasic mixture resulted in phase transfer of the silver nanoparticles from chloroform to water, giving a yellow, foam-like appearance to aqueous layer. This layer was then separated from the organic layer, dried and the resulting dry powder redispersed in 25 mL of double-distilled water.

### EXAMPLE 24

This example illustrates the phase transfer of hydrophobized silver nanoparticles with dimyristoyl-lecithin (DMPC) molecules at the chloroform-water interface and then the phase transfer of silver nano-particle in the aqueous phase. In a typical experiment, 25 mL of hydrophobized Ag (dodecylamine, octadecylamine, octadecathiol etc. capped) nanoparticles in chloroform was added to 25 mL of 10⁻³ M dimyristoyl-lecithin (DMPC) solution in water. The concentration of silver in chloroform was estimated to be 2×10⁻⁴ M by UV-vis. spectroscopy. Vigorous shaking of the biphasic mixture resulted in phase transfer of the silver nanoparticles from chloroform to water, giving a yellow, foam-like appearance to aqueous layer. This layer was then separated from the organic layer, dried and the resulting dry powder redispersed in 25 mL of double-distilled water.

### EXAMPLE 25

This example illustrates the phase transfer of hydrophobized silver nanoparticles with dipalmitoyl-lecithin (DPPC) molecules at the chloroform-water interface and then the phase transfer of silver nano-particle in the aqueous phase. In a typical experiment, 25 mL of hydrophobized Ag (dodecylamine, octadecylamine, octadecathiol etc. capped) nanoparticles in chloroform was added to 25 mL of 10⁻³ M dipalmitoyl-lecithin (DPPC) solution in water. The concentration of silver in chloroform was estimated to be 2×10⁻⁴ M by UV-vis. spectroscopy. Vigorous shaking of the biphasic mixture resulted in phase transfer of the silver nanoparticles from chloroform to water, giving a yellow, foam-like appearance to aqueous layer. This layer was then separated from the organic layer, dried and the resulting dry powder redispersed in 25 mL of double-distilled water.

### EXAMPLE 26

This example illustrates the phase transfer of hydrophobized silver nanoparticles with distearoyl-lecithin (DSPC) molecules at the chloroform-water interface and then the phase transfer of silver nano-particle in the aqueous phase. In a typical experiment, 25 mL of hydrophobized Ag (dodecylamine, octadecylamine, octadecathiol etc. capped) nanoparticles in chloroform was added to 25 mL of 10⁻³ M distearoyl-lecithin (DSPC) solution in water. The concentration of silver in chloroform was estimated to be 2×10⁻⁴ M by UV-vis. spectroscopy. Vigorous shaking of the biphasic mixture resulted in phase transfer of the silver nanoparticles from chloroform to Water, giving a yellow, foam-like appearance to aqueous layer. This layer was then separated from the organic layer, dried and the resulting dry powder redispersed in 25 mL of double-distilled water.

### EXAMPLE 27

This example illustrates the phase transfer of hydrophobized silver nanoparticles with dodacenedimethyl propanesultaine molecules at the chloroform-water interface and then the phase transfer of silver nanoparticle in the aqueous phase. In a typical experiment, 25 mL of hydrophobized Ag (dodecylamine, octadecylamine, octadecathiol etc. capped) nanoparticles in chloroform was added to 25 mL of 10⁻³ M dodacenedimethyl propanesultaine solution in water. The concentration of silver in chloroform was estimated to be 2×10⁻⁴ M by UV-vis. spectroscopy. Vigorous shaking of the biphasic mixture resulted in phase transfer of the silver nanoparticles from chloroform to water, giving a yellow, foam-like appearance to aqueous layer. This layer was then separated from the organic layer, dried and the resulting dry powder redispersed in 25 mL of double-distilled water.

### EXAMPLE 28

This example illustrates the phase transfer of hydrophobized silver nanoparticles with dodecyldimethyl amine oxide molecules at the chloroform-water interface and then the phase transfer of silver nanoparticle in the aqueous phase. In a typical experiment, 25 mL of hydrophobized Ag (dodecylamine, octadecylamine, octadecathiol etc. capped) nanoparticles in chloroform was added to 25 mL of 10⁻³ M dodecyidimethyl amine oxide solution in water. The concentration of gold in chloroform was estimated to be 2×10⁻⁴ M by UV-vis. spectroscopy. Vigorous shaking of the biphasic mixture resulted in phase transfer of the silver nanoparticles from chloroform to water, giving a yellow, foam-like appearance to aqueous layer. This layer was then separated from the organic layer, dried and the resulting dry powder redispersed in 25 mL of double-distilled water.

### EXAMPLE 29

This example illustrates the phase transfer of hydrophobized silver nanoparticles with 0-d-decylglucoside molecules at the chloroform-water interface and then the phase transfer of silver nano-particle in the aqueous phase. In a typical experiment, 25 mL of hydrophobized Ag (dodecylamine, octadecylamine, octadecathiol etc. capped) nanoparticles in chloroform was added to 25 mL of 10⁻³ M β-d-decylglucoside solution in water. The concentration of silver in chloroform was estimated to be 2×10⁻⁴ M by UV-vis. spectroscopy. Vigorous shaking of the biphasic mixture resulted in phase transfer of the silver nanoparticles from chloroform to water, giving a yellow, foam-like appearance to aqueous layer. This layer was then separated from the organic layer, dried and the resulting dry powder redispersed in 25 mL of double-distilled water.

### EXAMPLE 30

This example illustrates the phase transfer of hydrophobized silver nanoparticles with sodium octyldulfate molecules at the chloroform-water interface and then the phase transfer of silver nano-particle in the aqueous phase. In a typical experiment, 25 mL of hydrophobized Ag (dodecylamine, octadecylamine, octadecathiol etc. capped) nanoparticles in chloroform was added to 25 mL of 10⁻³ M sodium octyldulfate solution in water. The concentration of silver in chloroform was estimated to be 2×10⁻⁴ M by UV-vis. spectroscopy. Vigorous shaking of the biphasic mixture resulted in phase transfer of the silver nanoparticles from chlorofom to water, giving a yellow, foam-like appearance to aqueous layer. This layer was then separated from the organic layer, dried and the resulting dry powder redispersed in 25 mL of double-distilled water.

### EXAMPLE 31

This example illustrates the phase transfer of hydrophobized platinum nanoparticles with CTAB molecules at the chloroform-water interface and then the phase transfer of platinum nano-particle in the aqueous phase. In a typical experiment, 25 mL of hydrophobized Pt (dodecylamine, octadecylamine, octadecathiol etc. capped) nanoparticles in chloroform was added to 25 mL of 10⁻³ M CTAB solution in water. The concentration of platinum in organic solvent was estimated to be 2×10⁻⁴ M by UV-vis. spectroscopy. Vigorous shaking of the biphasic mixture resulted in phase transfer of the platinum nanoparticles from chloroform to water, giving a blackish brown, foam-like appearance to aqueous layer. This layer was then separated from the organic layer, dried and the resulting dry powder redispersed in 25 mL of double-distilled water.

### EXAMPLE 32

This example illustrates the phase transfer of hydrophobized platinum nanoparticles with sodium decylsulfate molecules at the chloroform-water interface and then the phase transfer of platinum nano-particle in the aqueous phase. In a typical experiment, 25 mL of hydrophobized Pt (dodecylamine, octadecylamine, octadecathiol etc. capped) nanoparticles in chloroform was added to 25 mL of 10⁻³ M sodium decylsulfate solution in water. The concentration of platinum in chloroform was estimated to be 2×10⁻⁴ M by UV-vis. spectroscopy. Vigorous shaking of the biphasic mixture resulted in phase transfer of the platinum nanoparticles from chloroform to water, giving a blackish-brown, foam-like appearance to aqueous layer. This layer was then separated from the organic layer, dried and the resulting dry powder redispersed in 25 mL of double-distilled water.

### EXAMPLE 33

This example illustrates the phase transfer of hydrophobized platinum nanoparticles with sodoum dodecyl sulphate(SDS) molecules at the chloroform water interface and then the phase transfer of platinum nanoparticle in the aqueous phase. In a typical experiment, 25 mL of hydrophobized Pt (dodecylamine, octadecylamine, octadecathiol etc. capped) nanoparticles in chloroform was added to 25 mL of 10⁻³ M sodoum dodecyl sulphate(SDS) solution in water. The concentration of platinum in chloroform was estimated to be 2×10⁻⁴ M by UV-vis. spectroscopy. Vigorous shaking of the biphasic mixture resulted in phase transfer of the platinum nanoparticles from chloroform to water, giving a blackish-brown, foam-like appearance to aqueous layer. This layer was then separated from the organic layer, dried and the resulting dry powder redispersed in 25 mL of double-distilled water.

### EXAMPLE 34

This example illustrates the phase transfer of hydrophobized platinum nanoparticles with sodium decanoate molecules at the chloroform water interface and then the phase transfer of platinum nano-particle in the aqueous phase. In a typical experiment, 25 mL of hydrophobized Pt (dodecylamine, octadecylamine, octadecathiol etc. capped) nanoparticles in chloroform was added to 25 mL of 10⁻³ M sodium decanoate solution in water. The concentration of platinum in chloroform was estimated to be 2×10⁻⁴ M by UV-vis. spectroscopy. Vigorous shaking of the biphasic mixture resulted in phase transfer of the platinum nanoparticles from chloroform to water, giving a blackish-brown, foam-like appearance to aqueous layer. This layer was then separated from the organic layer, dried and the resulting dry powder redispersed in 25 mL of double-distilled water.

### EXAMPLE 35

This example illustrates the phase transfer of hydrophobized platinum nanoparticles with aerosol OT (AOT) molecules at the chloroform water interface and then the phase transfer of platinum nano-particle in the aqueous phase. In a typical experiment, 25 mL of hydrophobized Pt (dodecylamine, octadecylamine, octadecathiol etc. capped) nanoparticles in chloroform was added to 25 mL of 10⁻³ M aerosol OT (AOT) solution in water. The concentration of platinum in chloroform was estimated to be 2×10⁻⁴ M by UV-vis. spectroscopy. Vigorous shaking of the biphasic mixture resulted in phase transfer of the platinum nanoparticles from chloroform to water, giving a blackish-brown, foam-like appearance to aqueous layer. This layer was then separated from the organic layer, dried and the resulting dry powder redispersed in 25 mL of double-distilled water.

### EXAMPLE 36

This example illustrates the phase transfer of hydrophobized platinum nanoparticles with Dodecyl trimethyl ammonium bromide molecules at the chloroform water interface and then the phase transfer of platinum nanoparticle in the aqueous phase. In a typical experiment, 25 mL of hydrophobized Pt (dodecylamine, octadecylamine, octadecathiol etc. capped) nanoparticles in chloroform was added to 25 mL of 10⁻³ M of Dodecyl trimethyl ammonium bromide solution in water. The concentration of platinum in chloroform was estimated to be 2×10⁻⁴ M by UV-vis. spectroscopy. Vigorous shaking of the biphasic mixture resulted in phase transfer of the platinum nanoparticles from chloroform to water, giving a blackish-brown, foam-like appearance to aqueous layer. This layer was then separated from the organic layer, dried and the resulting dry powder redispersed in 25 mL of double-distilled water.

### EXAMPLE 37

This example illustrates the phase transfer of hydrophobized platinum nanoparticles with didecyidimethyl ammonium bromide (DDAB) molecules at the chloroform-water interface and then the phase transfer of platinum nanoparticle in the aqueous phase. In a typical experiment, 25 mL of hydrophobized Pt (dodecylamine, octadecylamine, octadecathiol etc. capped) nanoparticles in chloroform was added to 25 mL of 10⁻³ M didecyldimethyl ammonium bromide (DDAB) solution in water. The concentration of platinum in chloroform was estimated to be 2×10⁻⁴ M by UV-vis. spectroscopy. Vigorous shaking of the biphasic mixture resulted in phase transfer of the platinum nanoparticles from chloroform to water, giving a blackish-brown, foam-like appearance to aqueous layer. This layer was then separated from the organic layer, dried and the resulting dry powder redispersed in 25 mL of double-distilled water.

### EXAMPLE 38

This example illustrates the phase transfer of hydrophobized platinum nanoparticles with Dihexadecyldimethyl ammonium acetate (DHDAA) molecules at the chloroform-water interface and then the phase transfer of platinum nano-particle in the aqueous phase. In a typical experiment, 25 mL of hydrophobized Pt (dodecylamine, octadecylamine, octadecathiol etc. capped) nanoparticles in chloroform was added to 25 mL of 10⁻³ M Dihexadecyldimethyl ammonium acetate (DHDAA) solution in water. The concentration of platinum in chloroform was estimated to be 2×10⁻⁴ M by UV-vis. spectroscopy. Vigorous shaking of the biphasic mixture resulted in phase transfer of the platinum nanoparticles from chloroform to water, giving a blackish-brown, foam-like appearance to aqueous layer. This layer was then separated from the organic layer, dried and the resulting dry powder redispersed in 25 mL of double-distilled water.

### EXAMPLE 39

This example illustrates the phase transfer of hydrophobized platinum nanoparticles with dimyristoyl-lecithin (DMPC) molecules at the chloroform-water interface and then the phase transfer of platinum nano-particle in the aqueous phase. In a typical experiment, 25 mL of hydrophobized Pt (dodecylamine, octadecylamine, octadecathiol etc. capped) nanoparticles in chloroform was added to 25 mL of 10⁻³ M dimyristoyl-lecithin (DMPC) solution in water. The concentration of platinum in chloroform was estimated to be 2×10⁻⁴ M by UV-vis. spectroscopy. Vigorous shaking of the biphasic mixture resulted in phase transfer of the platinum nanoparticles from chloroform to water, giving a blackish-brown, foam-like appearance to aqueous layer. This layer was then separated from the organic layer, dried and the resulting dry powder redispersed in 25 mL of double-distilled water.

### EXAMPLE 40

This example illustrates the phase transfer of hydrophobized platinum nanoparticles with dipalmitoyl-lecithin (DPPC) molecules at the chloroform-water interface and then the phase transfer of platinum nano-particle in the aqueous phase. In a typical experiment, 25 mL of hydrophobized Pt (dodecylamine, octadecylamine, octadecathiol etc. capped) nanoparticles in chloroform was added to 25 mL of 10⁻³ M dipalmitoyl-lecithin (DPPC) solution in water. The concentration of platinum in chloroform was estimated to be 2×10⁻⁴ M by UV-vis. spectroscopy. Vigorous shaking of the biphasic mixture resulted in phase transfer of the platinum nanoparticles from chloroform to water, giving a blackish-brown, foam-like appearance to aqueous layer. This layer was then separated from the organic layer, dried and the resulting dry powder redispersed in 25 mL of double-distilled water.

### EXAMPLE 41

This example illustrates the phase transfer of hydrophobized platinum nanoparticles with distearoyl-lecithin (DSPC) molecules at the chloroform-water interface and then the phase transfer of platinum nano-particle in the aqueous phase. In a typical experiment, 25 mL of hydrophobized Pt (dodecylamine, octadecylamine, octadecathiol etc. capped) nanoparticles in chloroform was added to 25 mL of 10⁻³ M distearoyl-lecithin (DSPC) solution in water. The concentration of platinum in chloroform was estimated to be 2×10⁻⁴ M by UV-vis. spectroscopy. Vigorous shaking of the biphasic mixture resulted in phase transfer of the platinum nanoparticles from chloroform to water, giving a blackish-brown, foam-like appearance to aqueous layer. This layer was then separated from the organic layer, dried and the resulting dry powder redispersed in 25 mL of double-distilled water.

### EXAMPLE 42

This example illustrates the phase transfer of hydrophobized platinum nanoparticles with dodacenedimethyl propanesultaine molecules at the chloroform-water interface and then the phase transfer of platinum nanoparticle in the aqueous phase. In a typical experiment, 25 mL of hydrophobized Pt (dodecylamine, octadecylamine, octadecathiol etc. capped) nanoparticles in chloroform was added to 25 mL of 10⁻³ M dodacenedimethyl propanesultaine solution in water. The concentration of platinum in chloroform was estimated to be 2×10⁻⁴ M by UV-vis. spectroscopy. Vigorous shaking of the biphasic mixture resulted in phase transfer of the platinum nanoparticles from chloroform to water, giving a blackish-brown, foam-like appearance to aqueous layer. This layer was then separated from the organic layer, dried and the resulting dry powder redispersed in 25 mL of double-distilled water.

### EXAMPLE 43

This example illustrates the phase transfer of hydrophobized platinum nanoparticles with dodecyldimethyl amine oxide molecules at the chloroform-water interface and then the phase transfer of platinum nanoparticle in the aqueous phase. In a typical experiment, 25 mL of hydrophobized Pt (dodecylamine, octadecylamine, octadecathiol etc. capped) nanoparticles in chloroform was added to 25 mL of 10⁻³ M dodecyidimethyl amine oxide solution in water. The concentration of platinum in chloroform was estimated to be 2×10⁻⁴ M by UV-vis. spectroscopy. Vigorous shaking of the biphasic mixture resulted in phase transfer of the platinum nanoparticles from chloroform to water, giving a blackish-brown, foam-like appearance to aqueous layer. This layer was then separated from the organic layer, dried and the resulting dry powder redispersed in 25 mL of double-distilled water.

### EXAMPLE 44

This example illustrates the phase transfer of hydrophobized platinum nanoparticles with P-d-decylglucoside molecules at the chloroform-water interface and then the phase transfer of platinum nano-particle in the aqueous phase. In a typical experiment, 25 mL of hydrophobized Pt (dodecylamine, octadecylamine, octadecathiol etc. capped) nanoparticles in chloroform was added to 25 mL of 10⁻³ M β-d-decylglucoside solution in water. The concentration of platinum in chloroform was estimated to be 2×10⁻⁴ M by UV-vis. spectroscopy. Vigorous shaking of the biphasic mixture resulted in phase transfer of the platinum nanoparticles from chloroform to water, giving a blackish-brown, foam-like appearance to aqueous layer. This layer was then separated from the organic layer, dried and the resulting dry powder redispersed in 25 mL of double-distilled water.

### EXAMPLE 45

This example illustrates the phase transfer of hydrophobized platinum nanoparticles with sodium octyldulfate molecules at the chloroform-water interface and then the phase transfer of platinum nano-particle in the aqueous phase. In a typical experiment, 25 mL of hydrophobized Pt (dodecylamine, octadecylamine, octadecathiol etc. capped) nanoparticles in chloroform was added to 25 mL of 10⁻³ M sodium octyidulfate solution in water. The concentration of platinum in chloroform was estimated to be 2×10⁻⁴ M by UV-vis. spectroscopy. Vigorous shaking of the biphasic mixture resulted in phase transfer of the platinum nanoparticles from chlorofom to water, giving a blackish-brown, foam-like appearance to aqueous layer. This layer was then separated from the organic layer, dried and the resulting dry powder redispersed in 25 mL of double-distilled water.

### EXAMPLE 46

This example illustrates the phase transfer of hydrophobized palladium nanoparticles with CTAB molecules at the chloroform-water interface and then the phase transfer of palladium nano-particle in the aqueous phase. In a typical experiment, 25 mL of hydrophobized Pd (dodecylamine, octadecylamine, octadecathiol etc. capped) nanoparticles in chloroform was added to 25 mL of 10⁻³ M- CTAB solution in water. The concentration of palladium in organic solvent was estimated to be 2×10⁻⁴ M by UV-vis. spectroscopy. Vigorous shaking of the biphasic mixture resulted in phase transfer of the palladium nanoparticles from chloroform to water, giving a brownish, foam-like appearance to aqueous layer. This layer was then separated from the organic layer, dried and the resulting dry powder redispersed in 25 mL of double-distilled water.

### EXAMPLE 47

This example illustrates the phase transfer of hydrophobized palladium nanoparticles with sodium decylsulfate molecules at the chloroform-water interface and then the phase transfer of palladium nano-particle in the aqueous phase. In a typical experiment, 25 mL of hydrophobized Pd (dodecylamine, octadecylamine, octadecathiol etc. capped) nanoparticles in chloroform was added to 25 mL of 10⁻³ M sodium decylsulfate solution in water. The concentration of palladium in chloroform was estimated to be 2×10⁻⁴ M by UV-vis. spectroscopy. Vigorous shaking of the biphasic mixture resulted in phase transfer of the palladium nanoparticles from chloroform to water, giving a brownish foam-like appearance to aqueous layer. This layer was then separated from the organic layer, dried and the resulting dry powder redispersed in 25 mL of double-distilled water.

### EXAMPLE 48

This example illustrates the phase transfer of hydrophobized palladium nanoparticles with sodoum dodecyl sulphate(SDS) molecules at the chloroform water interface and then the phase transfer of palladium nanoparticle in the aqueous phase. In a typical experiment, 25 mL of hydrophobized Pd (dodecylamine, octadecylamine, octadecathiol etc. capped) nanoparticles in organic solvent was added to 25 mL of 10⁻³ M sodoum dodecyl sulphate(SDS) solution in water. The concentration of palladium in chloroform was estimated to be 2×10⁻⁴ M by UV-vis. spectroscopy. Vigorous shaking of the biphasic mixture resulted in phase transfer of the palladium nanoparticles from chloroform to water, giving a brownish, foam-like appearance to aqueous layer. This layer was then separated from the organic layer, dried and the resulting dry powder redispersed in 25 mL of double-distilled water.

### EXAMPLE 49

This example illustrates the phase transfer of hydrophobized palladium nanoparticles with sodium decanoate molecules at the chloroform water interface and then the phase transfer of palladium nano-particle in the aqueous phase. In a typical experiment, 25 mL of hydrophobized Pd (dodecylamine, octadecylamine, octadecathiol etc. capped) nanoparticles in chloroform was added to 25 mL of 10⁻³ M sodium decanoate solution in water. The concentration of palladium in chloroform was estimated to be 2×10⁻⁴ M by UV-vis. spectroscopy. Vigorous shaking of the biphasic mixture resulted in phase transfer of the palladium nanoparticles from chloroform to water, giving brownish, foam-like appearance to aqueous layer. This layer was then separated from the organic layer, dried and the resulting dry powder redispersed in 25 mL of double-distilled water.

### EXAMPLE 50

This example illustrates the phase transfer of hydrophobized palladium nanoparticles with aerosol OT (AOT) molecules at the chloroform water interface and then the phase transfer of palladium nano-particle in the aqueous phase. In a typical experiment, 25 mL of hydrophobized Pd (dodecylamine, octadecylamine, octadecathiol etc. capped) nanoparticles in chloroform was added to 25 mL of 10⁻³ M aerosol OT (AOT) solution in water. The concentration of palladium in chloroform was estimated to be 2×10⁻⁴ M by UV-vis. spectroscopy. Vigorous shaking of the biphasic mixture resulted in phase transfer of the palladium nanoparticles from chloroform to water, giving a brownish foam-like appearance to aqueous layer. This layer was then separated from the organic layer, dried and the resulting dry powder redispersed in 25 mL of double-distilled water.

### EXAMPLE 51

This example illustrates the phase transfer of hydrophobized palladium nanoparticles with Dodecyl trimethyl ammonium bromide molecules at the chloroform water interface and then the phase transfer of palladium nanoparticle in the aqueous phase. In a typical experiment, 25 mL of hydrophobized Pd (dodecylamine, octadecylamine, octadecathiol etc. capped) nanoparticles in chloroform was added to 25 mL of 10⁻³ M of Dodecyl trimethyl ammonium bromide solution in water. The concentration of palladium in chloroform was estimated to be 2×10⁻⁴ M by UV-vis. spectroscopy. Vigorous shaking of the biphasic mixture resulted in phase transfer of the palladium nanoparticles from chloroform to water, giving a brownish foam-like appearance to aqueous layer. This layer was then separated from the organic layer, dried and the resulting dry powder redispersed in 25 mL of double-distilled water.

### EXAMPLE 52

This example illustrates the phase transfer of hydrophobized palladium nanoparticles with didecyidimethyl ammonium bromide (DDAB) molecules at the chloroform-water interface and then the phase transfer of palladium nano-particle in the aqueous phase. In a typical experiment, 25 mL of hydrophobized Pd (dodecylamine, octadecylamine, octadecathiol etc. capped) nanoparticles in chloroform was added to 25 mL of 10⁻³ M didecyldimethyl ammonium bromide (DDAB) solution in water. The concentration of palladium in chloroform was estimated to be 2×10⁻⁴ M by UV-vis. spectroscopy. Vigorous shaking of the biphasic mixture resulted in phase transfer of the palladium nanoparticles from chloroform to water, giving a brownish foam-like appearance to aqueous layer. This layer was then separated from the organic layer, dried and the resulting dry powder redispersed in 25 mL of double-distilled water.

### EXAMPLE 53

This example illustrates the phase transfer of hydrophobized palladium nanoparticles with Dihexadecyidimethyl ammonium acetate (DHDAA) molecules at the chloroform-water interface and then the phase transfer of palladium nano-particle in the aqueous phase. In a typical experiment, 25 mL of hydrophobized Pd (dodecylamine, octadecylamine, octadecathiol etc. capped) nanoparticles in chloroform was added to 25 mL of 10⁻³ M Dihexadecyldimethyl ammonium acetate (DHDAA) solution in water. The concentration of palladium in chloroform was estimated to be 2×10⁻⁴ M by UV-vis. spectroscopy. Vigorous shaking of the biphasic mixture resulted in phase transfer of the palladium nanoparticles from chloroform to water, giving a brownish foam-like appearance to aqueous layer. This layer was then separated from the organic layer, dried and the resulting dry powder redispersed in 25 mL of double-distilled water.

### EXAMPLE 54

This example illustrates the phase transfer of hydrophobized palladium nanoparticles with dimyristoyl-lecithin (DMPC) molecules at the chloroform-water interface and then the phase transfer of palladium nano-particle in the aqueous phase. In a typical experiment, 25 mL of hydrophobized Pd (dodecylamine, octadecylamine, octadecathiol etc. capped) nanoparticles in chloroform was added to 25 mL of 10⁻³ M dimyristoyl-lecithin (DMPC) solution in water. The concentration of palladium in chloroform was estimated to be 2×10⁻⁴ M by UV-vis. spectroscopy. Vigorous shaking of the biphasic mixture resulted in phase transfer of the palladium nanoparticles from chloroform to water, giving a brownish foam-like appearance to aqueous layer. This layer was then separated from the organic layer, dried and the resulting dry powder redispersed in 25 mL of double-distilled water.

### EXAMPLE 55

This example illustrates the phase transfer of hydrophobized palladium nanoparticles with dipalmitoyl-lecithin (DPPC) molecules at the chloroform-water interface and then the phase transfer of palladium nano-particle in the aqueous phase. In a typical experiment, 25 mL of hydrophobized Pd (dodecylamine, octadecylamine, octadecathiol etc. capped) nanoparticles in chloroform was added to 25 mL of 10⁻³ M dipalmitoyl-lecithin (DPPC) solution in water. The concentration of palladium in chloroform was estimated to be 2×10⁻⁴ M by UV-vis. spectroscopy. Vigorous shaking of the biphasic mixture resulted in phase transfer of the palladium nanoparticles from chloroform to water, giving a brownish foam-like appearance to aqueous layer. This layer was then separated from the organic layer, dried and the resulting dry powder redispersed in 25 mL of double-distilled water.

### EXAMPLE 56

This example illustrates the phase transfer of hydrophobized palladium nanoparticles with distearoyl-lecithin (DSPC) molecules at the chloroform-water interface and then the phase transfer of palladium nano-particle in the aqueous phase. In a typical experiment, 25 mL of hydrophobized Pd (dodecylamine, octadecylamine, octadecathiol etc. capped) nanoparticles in chloroform was added to 25 mL of 10⁻³ M distearoyl-lecithin (DSPC) solution in water. The concentration of palladium in chloroform was estimated to be 2×10⁻⁴ M by UV-vis. spectroscopy. Vigorous shaking of the biphasic mixture resulted in phase transfer of the palladium nanoparticles from chloroform to water, giving a brownish foam-like appearance to aqueous layer. This layer was then separated from the organic layer, dried and the resulting dry powder redispersed in 25 mL of double-distilled water.

### EXAMPLE 57

This example illustrates the phase transfer of hydrophobized palladium nanoparticles with dodacenedimethyl propanesultaine molecules at the chloroform-water interface and then the phase transfer of palladium nanoparticle in the aqueous phase. In a typical experiment, 25 mL of hydrophobized Pd (dodecylamine, octadecylamine, octadecathiol etc. capped) nanoparticles in chloroform was added to 25 mL of 10⁻³ M dodacenedimethyl propanesultaine solution in water. The concentration of palladium in chloroform was estimated to be 2×10⁻⁴ M by UV-vis. spectroscopy. Vigorous shaking of the biphasic mixture resulted in phase transfer of the palladium nanoparticles from chlorofom to water, giving a balckish-brown, foam-like appearance to aqueous layer. This layer was then separated from the organic layer, dried and the resulting dry powder redispersed in 25 mL of double-distilled water.

### EXAMPLE 58

This example illustrates the phase transfer of hydrophobized palladium nanoparticles with dodecyldimethyl amine oxide molecules at the chloroform-water interface and then the phase transfer of palladium nanoparticle in the aqueous phase. In a typical experiment, 25 mL of hydrophobized Pd (dodecylamine, octadecylamine, octadecathiol etc. capped) nanoparticles in chloroform was added to 25 mL of 10⁻³ M dodecyldimethyl amine oxide solution in water. The concentration of palladium in chloroform was estimated to be 2×10⁻⁴ M by UV-vis. spectroscopy. Vigorous shaking of the biphasic mixture resulted in phase transfer of the palladium nanoparticles from chloroform to water, giving a brownish foam-like appearance to aqueous layer. This layer was then separated from the organic layer, dried and the resulting dry powder redispersed in 25 mL of double-distilled water.

### EXAMPLE 59

This example illustrates the phase transfer of hydrophobized palladium nanoparticles with -d-decylglucoside molecules at the chloroform-water interface and then the phase transfer of palladium nano-particle in the aqueous phase. In a typical experiment, 25 mL of hydrophobized Pd (dodecylamine, octadecylamine, octadecathiol etc. capped) nanoparticles in chloroform was added to 25 mL of 10⁻³ M β-d-decylglucoside solution in water. The concentration of palladium in chloroform was estimated to be 2×10⁻⁴ M by UV-vis. spectroscopy. Vigorous shaking of the biphasic mixture resulted in phase transfer of the palladium nanoparticles from chloroform to water, giving a brownish foam-like appearance to aqueous layer. This layer was then separated from the organic layer, dried and the resulting dry powder redispersed in 25 mL of double-distilled water.

### EXAMPLE 60

This example illustrates the phase transfer of hydrophobized palladium nanoparticles with sodium octyidulfate molecules at the chloroform-water interface and then the phase transfer of palladium nano-particle in the aqueous phase. In a typical experiment, 25 mL of hydrophobized Pd (dodecylamine, octadecylamine, octadecathiol etc. capped) nanoparticles in chloroform was added to 25 mL of 10⁻³ M sodium octyldulfate solution in water. The concentration of palladium in chloroform was estimated to be 2×10⁻⁴ M by UV-vis. spectroscopy. Vigorous shaking of the biphasic mixture resulted in phase transfer of the palladium nanoparticles from chloroform to water, giving a brownish foam-like appearance to aqueous layer. This layer was then separated from the organic layer, dried and the resulting dry powder redispersed in 25 mL of double-distilled water.

On the contrary the process of present invention is:
(1) better, faster, involves very less maneuvering, simple and is based on interdigitation of hydrocarbon chains of surfactant molecules and hydrophobic nanoparticles,
(2) which does not change the nature of nanoparticle surface and results is complete phase transfer from organic medium to aqueous medium.
(3) Phase transfer can be done by any water soluble surfactant which is readily available and cheaper than other place exchange molecule.

1. A process for the preparation of water dispersible nanoparticles comprising mixing a solution of a surfactant in a polar solvent with a solution of hydrophobic nanoparticles in an organic solvent.

2. The process of claim 1, further comprising agitating the mixture comprising the polar surfactant dissolved in the polar solvent and the solution of hydrophobic nanoparticles in the organic solvent.

3. The process of claim 2, wherein the mixture is agitated for at least approximately 30 minutes.

4. The process of claim 2, wherein the mixture is agitated for a period of approximately 30 minutes to approximately 60 minutes.

5. The process of claim 1, wherein the hydrophobic nanoparticles comprise metal colloidal particles.

6. The process of claim 1, wherein the hydrophobic nanoparticles comprise gold, silver, nickel, platinum, palladium, ruthenium or mixtures thereof.

7. The process of claim 1, wherein the hydrophobic nanoparticles comprise semiconductor nanoparticles.

8. The process of claim 1, wherein the hydrophobic nanoparticles comprise cadmium sulphide, cadmium selenide, cadmium telluride, gold sulphide, silver sulphide, zinc sulphide, zirconia, titania, and mixtures thereof.

9. The process of claim 1, wherein the surfactant comprises sodium octylsulfate, sodium decylsulfate, sodium dodecylsulfate, sodium dodecanoate, aerosol OT, dodecyl trimethyl ammonium bromide, hexadecyltrimethyl ammonium bromide, didecyldimethyl ammonium bromide, dihexadecyldimethyl ammonium acetate, dimyristoyl-lecithin, dipalmitoyl-lecithin, distearoyl-lecithin, dodacenedimethyl propanesultaine, dodecyldimethyl amine oxide, β-d-decylglucoside, or mixtures thereof.

10. The process of claim 1, wherein a concentration of the surfactant in the polar medium is approximately 2 times to approximately 10 times greater than a concentration of the hydrophobic nanoparticles in the organic solvent.

11. The process of claim 1, wherein the polar solvent comprises water.
